(19) United States
(12) Patent Application Publication
(10) Pub. No.: US 2002/0085762 A1
(43) Pub. Date: Jul. 4, 2002

(54) Mass event image identification

(75) Inventors: Moti Shniberg, Elkannah (IL); Yaron Nemet, Kedumim (IL); Elliott Sussman, Raanana (IL)

Correspondence Address: Ladas & Parry, 26 West 61st Street, New York, NY, 10023, US

(73) Assignee: IMAGE ID LTD.

(21) Appl. No.: 09/897,686

(22) Filed: Jul. 2, 2001

Related U.S. Application Data
(60) Provisional application No. 60/245,394, filed on Nov. 1, 2000.

(51) Int. Cl. G06K 9/62; G06K 9/64

(52) U.S. Cl. 382/224; 382/278

(57) ABSTRACT

A system and method for providing photographs of spectators at an event employing photography equipment, producing photographs of a plurality of spectators at an event and a correlator providing a correlation output correlating information contained in the photographs of the plurality of spectators with identifying information relating individual ones of the plurality of spectators to photographs of the individual ones of the plurality of spectators.

### REFERENCE TO CO-PENDING APPLICATIONS

Applicants hereby claim priority of U.S. Provisional Patent Application U.S. Serial No. 60/245,394, filing date Nov. 2, 2000 and entitled “Mass Event”.

### FIELD OF THE INVENTION

The present invention relates to photography generally and more particularly to systems and methodologies for identifying persons appearing in photographs.

### BACKGROUND OF THE INVENTION

The following publications are believed to represent the current state of the art:

Published PCT Patent Applications WO 00/04711 of the present assignee and WO 98/10358;

U.S. patents:

| | | | | | |
|---|---|---|---|---|---|
| 5,852,823; | 5,852,669; | 5,850,470; | 5,835,625; | 5,835,616; | 5,828,779; |
| 5,826,242; | 5,825,881; | 5,818,953; | 5,805,720; | 5,802,208; | 5,801,763; |
| 5,976,351; | 5,794,217; | 5,787,186; | 5,779,284; | 5,774,873; | 5,754,656; |
| 5,751,847; | 5,745,681; | 5,729,619; | 5,724,522; | 5,721,832; | 5,717,923; |
| 5,715,400; | 5,715,325; | 5,694,514; | 5,666,215; | 5,664,111; | 5,655,053; |
| 5,652,881; | 5,644,765; | 5,642,431; | 5,642,160; | 5,629,990; | 5,629,981; |
| 5,602,375; | 5,598,208; | 5,583,614; | 5,576,838; | 5,566,327; | 5,554,984; |
| 5,550,928; | 5,524,065; | 5,459,797; | 5,432,864; | 5,430,809; | 5,410,609; |
| 5,383,111; | 5,381,155; | 5,375,177; | 5,363,504; | 5,321,396; | 5,164,992; |
| 5,120,126; | 5,031,224; | 5,012,522; | 4,991,223; | 4,991,205; | 4,975,969; |
| 4,797,937; | 4,790,022; | 4,734,725; | 4,547,896; | 4,414,635; | 4,110,826; |
| 4,009,466; | 3,938,088. | | | | |

### SUMMARY OF THE INVENTION

The present invention seeks to provide systems and functionalities for providing photographs of spectators at events.

There is thus provided in accordance with a preferred embodiment of the present invention a system for providing photographs of spectators at an event including:

photography equipment, producing photographs of a plurality of spectators at an event; and

a correlator providing a correlation output correlating information contained in the photographs of the plurality of spectators with identifying information relating individual ones of the plurality of spectators to photographs of the individual ones of the plurality of spectators.

There is additionally provided in accordance with a preferred embodiment of the present invention a system for providing photographs of spectators at an event and wherein the correlator includes:

first correlation functionality which employs individual identification information provided by identifiers worn by individual ones of the plurality of spectators, which individual identification information is extracted from the photographs.

There is further provided in accordance with a preferred embodiment of the present invention a system for providing photographs of spectators at an event and wherein the correlator includes:

second correlation functionality which employs the assigned locations of individual ones of the plurality of spectators to provide individual identification information.

Preferably, the system also includes a distribution sub-system which is operative to make the photographs available to individual ones of the plurality of spectators appearing in the photographs on the basis of the correlation output.

Additionally or alternatively, the system also includes a distribution sub-system which includes an identifier-based indexer operative using information related to identifiers for identifying photographs in which identifier bearing individual ones of the plurality of spectators appear.

Further in accordance with a preferred embodiment of the present invention, the system also includes a distribution sub-system which includes an assigned location-based indexer operative using information related to assigned locations of individual ones of the plurality of spectators for identifying photographs in which individual ones of the plurality of spectators at the assigned locations appear.

Preferably, the distribution sub-system also includes a computer network based system wherein identifier based information is entered to receive access to photographs in which an identifier-based spectator appears.

In accordance with a preferred embodiment of the present invention, the distribution sub-system also includes a computer network based system wherein location based information is entered to receive access to photographs in which an spectator appears at a given location.

There is additionally provided in accordance with a preferred embodiment of the present invention a method for providing photographs of spectators at an event including:

producing photographs of a plurality of spectators at an event; and

providing a correlation output correlating information contained in the photographs of the plurality of spectators with identifying information relating individual ones of the plurality of spectators to photographs of the individual ones of the plurality of spectators.

There is further provided in accordance with a preferred embodiment of the present invention a method for providing photographs of spectators at an event and wherein the correlating includes:

first correlation functionality which employs individual identification information provided by identifiers worn by individual ones of the plurality of spectators, which individual identification information is extracted from the photographs.

There is additionally provided in accordance with a preferred embodiment of the present invention a method for providing photographs of spectators at an event and wherein the correlating includes:

second correlation functionality which employs the assigned locations of individual ones of the plurality of spectators to provide individual identification information.

Preferably, the method also includes making the photographs available to individual ones of the plurality of spectators appearing in the photographs on the basis of the correlation output.

In accordance with one embodiment of the present invention, the making includes:

using information related to identifiers for identifying photographs in which identifier bearing individual ones of the plurality of spectators appear.

Additionally or alternatively, the making includes:

using information related to assigned locations of individual ones of the plurality of spectators for identifying photographs in which individual ones of the plurality of spectators at the assigned locations appear.

As a further addition or alternative, the making includes entering identifier based information into a computer network to receive access to photographs in which an identifier-based spectator appears.

Further additionally or alternatively, the making includes entering location based information into a computer network to receive access to photographs in which a spectator appears at a given location.

There is also provided in accordance with a preferred embodiment of the present invention a photograph classifier providing a photograph classification output classifying the photographs according to at least one classification criterion.

In accordance with one embodiment of the present invention, the photograph classifier provides the classification output according to at least a classification criteria based on information contained in the photographs other than the identifying information.

Alternatively or additionally, the photograph classifier provides the classification output according to at least a classification criteria based on information not contained in the photographs.

The classification criteria may include, for example, sound or other information indicating the existence of spectator excitement, indicating presence of a given logo or symbol or indicating that a spectator is identified with a given team or sponsor in a visually sensible manner.

The system may also include an output device receiving the photograph classification output and providing a photograph classification dependent output. The output device may include, for example, a still photograph storage device which stores photographs in accordance with the photograph classification output, a still photograph distribution device which makes photographs available for distribution in accordance with the photograph classification output, a still photograph selection device which selects photographs in accordance with the photograph classification output or an Internet still photograph distribution subsystem which makes photographs available for download in accordance with the photograph classification output.

The Internet still photograph distribution subsystem may include an audio sound bite functionality, which would make concurrent sound bites available for download together with the photographs.

### BRIEF DESCRIPTION OF THE DRAWINGS

The present invention will be understood and appreciated more fully from the following detailed description, taken in conjunction with the drawings in which:

FIG. 1 is a simplified pictorial illustration of a system and methodology for providing photographs of spectators at an event in accordance with a preferred embodiment of the present invention;

FIG. 2 is a simplified pictorial illustration of a system and methodology for providing photographs of spectators at an event in accordance with another preferred embodiment of the present invention;

FIG. 3 is a simplified pictorial illustration of a system and methodology for providing photographs of spectators at an event in accordance with yet another preferred embodiment of the present invention;

FIG. 4 is a simplified pictorial illustration of a real-time photograph access feature applicable to the embodiments of FIGS. 1 & 2;

FIGS. 5A and 5B are simplified pictorial illustrations of use of an image code for automated access control at an event in accordance with two alternative embodiments of the present invention;

FIG. 6 is a simplified pictorial illustration of delivery of products to a spectator in accordance with a preferred embodiment of the present invention; and

FIG. 7 is a simplified flow chart illustrating the operation of the present invention.

### DETAILED DESCRIPTION OF PREFERRED EMBODIMENTS

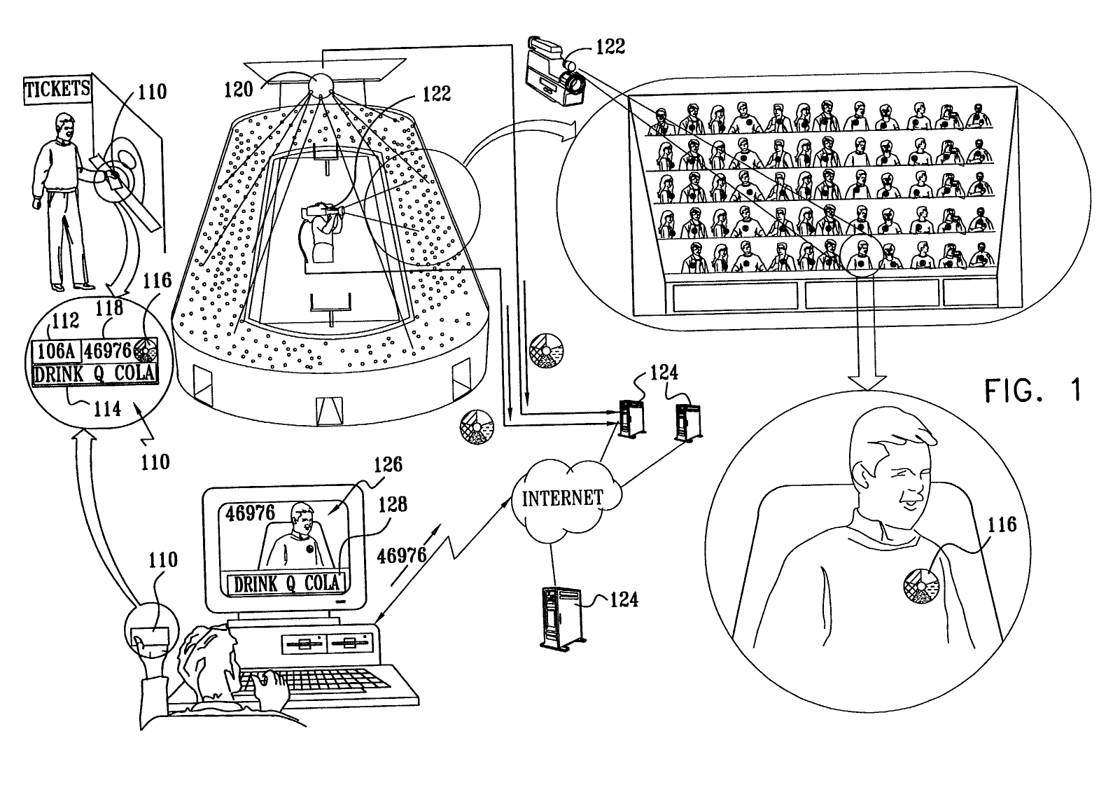

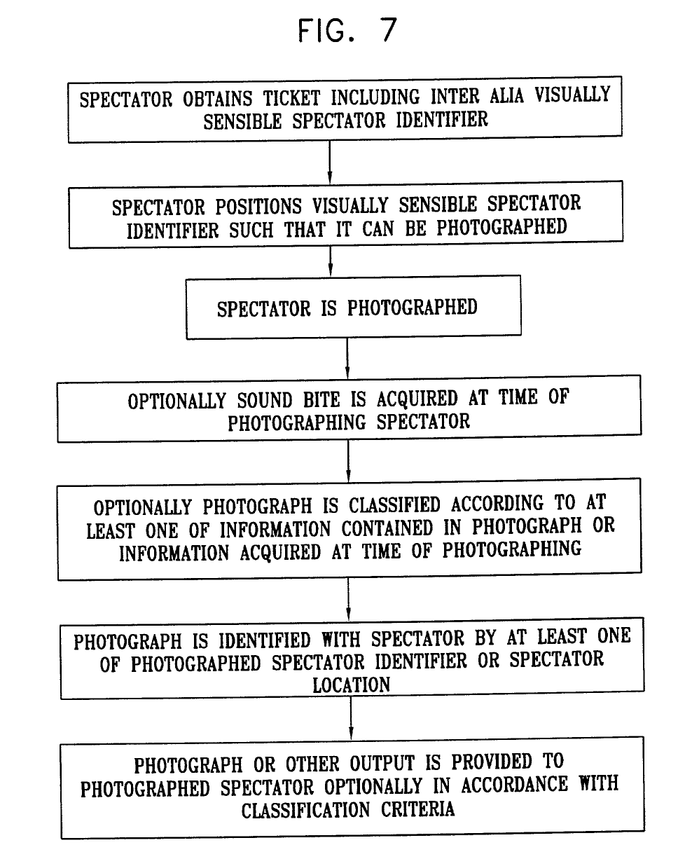

Reference is now made to FIG. 1, which is a simplified pictorial illustration of a system and methodology for providing photographs of spectators at an event in accordance with a preferred embodiment of the present invention and to FIG. 7, which is a simplified flow chart illustrating the methodology.

As seen in FIG. 1, in accordance with a preferred embodiment of the present invention, a spectator at an event purchases or otherwise obtains a ticket 110, which typically includes, inter alia seat location indicia 112, advertising content 114, a removable spectator identifier 116 and a spectator identification code 118, which is keyed to the removable spectator identifier 116.

In accordance with a preferred embodiment of the present invention, the spectator identifier 116 comprises a multi-segment color coded tag, such as a tag 116 illustrated in FIGS. 10 and 19 and described at pages 13, 20 & 21 of applicant/assignee's published PCT Patent Application WO 00/04711, the disclosure of which is hereby incorporated by reference.

In accordance with a preferred embodiment of the present invention, the spectator removes the removable spectator identifier 116 from the ticket and adheres it to his outer clothing. The spectator is photographed wearing the spectator identifier 116, while in an arena or other suitable location, preferably by one or more static cameras 120 and/or by one or more moving cameras 122. Any suitable type of photography may be employed, such as still photography, video photography and both digital and analog media may be employed.

Optionally, at the time of acquisition of the photographs, sound bites may also be acquired. This may be particularly meaningful during instances of excitement in sports or other events, when the image of the spectator may have a real correlation to the concurrent sounds.

In accordance with a preferred embodiment of the present invention, photographs may be classified not only according to the identity of the spectator, but also according to one or more additional criteria. These criteria may be based on information contained in the photographs and additionally or alternatively may be based on information not contained in the photographs, such as concurrently acquired audio content, such as sound bites.

For example, photographs taken at times of excitement, as evidenced by either or both visual characteristics of the photographed spectators or concurrently acquired sound bites, may be considered to be preferable over other photographs and may be made available with a higher priority.

As another example, photographs of spectators wearing certain clothing or holding products associated with certain sponsors may be provided to the spectators at no cost or lowered cost by the sponsors.

The photographed content and any acquired concurrent sound bites are preferably loaded in real time or promptly after an event to one or more servers 124. This content preferably includes spectator identification data corresponding to each spectator identifier 116 photographed on a spectator. Servers 124 are preferably accessible via the Internet.

In accordance with a preferred embodiment of the present invention, a spectator or any other person having access to ticket 110 or who has otherwise received the identification code 118 may view any picture taken of a spectator wearing a spectator identifier 116 by entering a suitable web site and then, typically in response to suitable prompts, entering the spectator identification code 118, which corresponds to the spectator identification data provided by the spectator identifier 116. In response to entry of the spectator identification code 118, the viewer sees a picture 126 of the spectator and typically also views suitable advertising content 128. The viewer may then conveniently purchase a download of the picture 126 and any other ancillary products or services, such as T-shirts, mugs and e-mail greetings with pictures.

Where concurrent sound bites are recorded, these may be played to the viewer at the time of viewing the photograph.

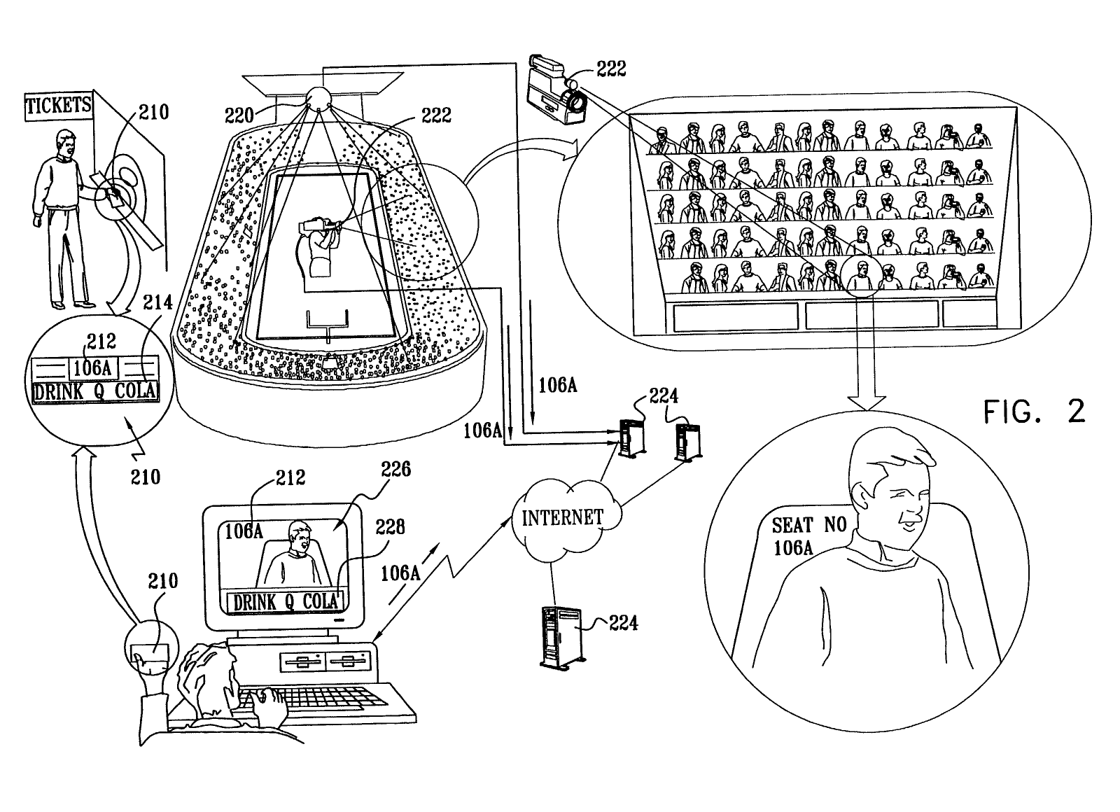

Reference is now made to FIG. 2, which is a simplified pictorial illustration of a system and methodology for providing photographs of spectators at an event in accordance with another preferred embodiment of the present invention and to FIG. 7, which is a simplified flow chart illustrating the methodology.

As seen in FIG. 2, in accordance with a preferred embodiment of the present invention, a spectator at an event purchases or otherwise obtains a ticket 210, which typically includes, inter alia seat location indicia 212 and advertising content 214.

In accordance with a preferred embodiment of the present invention, the spectator is photographed typically while seated or standing in his assigned seat as identified by the seat location indicia 212 on the ticket 210 in an arena or other suitable location, preferably by one or more static cameras 220 and/or by one or more moving cameras 222. Any suitable type of photography may be employed, such as still photography, video photography and both digital and analog media may be employed.

The photographed content is preferably loaded in real time or promptly after an event to one or more servers 224. This content preferably includes seat location data corresponding to each spectator photographed. The seat location data may be derived from one or more sources, such as fixed viewable indicia in the arena or other location or outputs of an inertial or other suitable sensor. Servers 224 are preferably accessible via the Internet.

In accordance with a preferred embodiment of the present invention, a spectator or any other person having access to ticket 210 or who has otherwise received the seat location data may view any picture taken of a spectator located at the indicated seat location by entering a suitable web site and then, typically in response to suitable prompts, entering the seat location indicia 212.

In response to entry of the seat location indicia 212, the viewer sees a picture 226 of the spectator and typically also views suitable advertising content 228. The viewer may then conveniently purchase a download of the picture 226 and any other ancillary products or services, such as T-shirts, mugs and e-mail greetings with pictures.

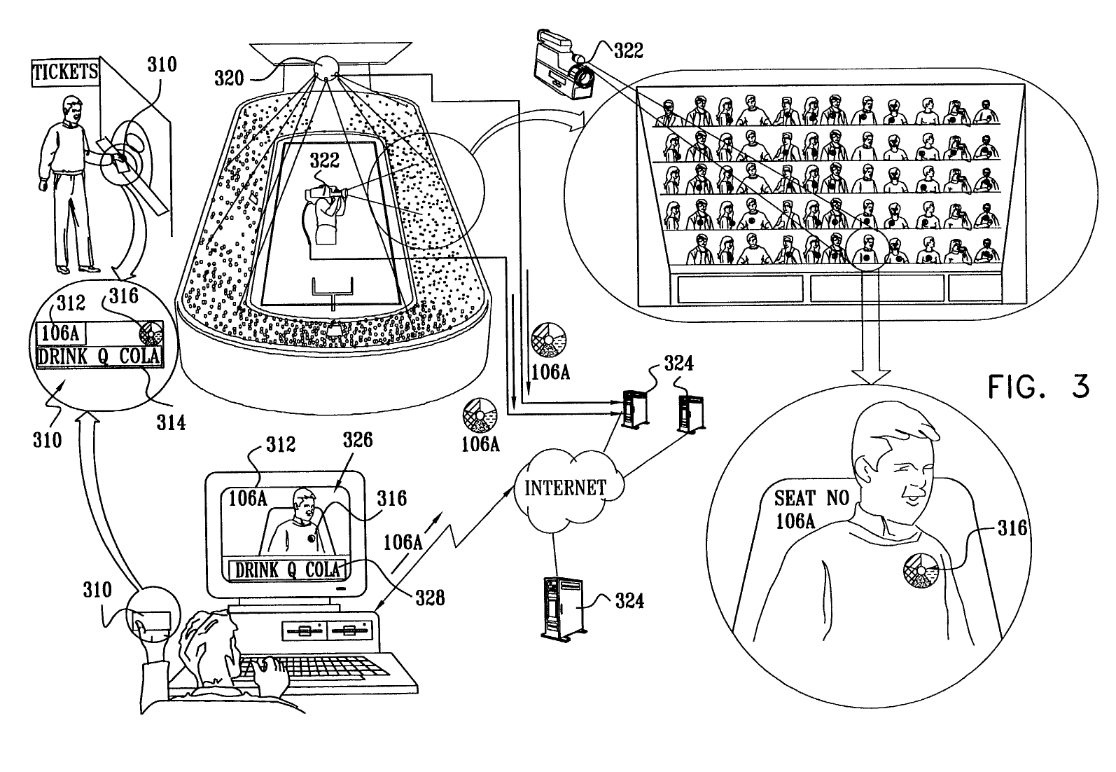

Reference is now made to FIG. 3, which is a simplified pictorial illustration of a system and methodology for providing photographs of spectators at an event in accordance with yet another preferred embodiment of the present invention.

As seen in FIG. 3, in accordance with a preferred embodiment of the present invention, a spectator at an event purchases or otherwise obtains a ticket 310, which typically includes, inter alia seat location indicia 312, advertising content 314 and a removable spectator indicator 316.

In accordance with a preferred embodiment of the present invention, the spectator indicator 316 comprises a multi-segment color coded tag, such as a tag 316 illustrated in FIGS. 10 and 19 and described at pages 13, 20 & 21 of applicant/assignee's published PCT Patent Application WO 00/04711, the disclosure of which is hereby incorporated by reference. Alternatively the spectator indicator may be any suitable, not individualized non-coded tag. The spectator indicator 316 may be employed in the embodiment of FIG. 3 merely for indicating that a spectator wishes to have his picture made available for viewing via the system and methodology of the present invention.

In accordance with a preferred embodiment of the present invention, the spectator may remove the removable spectator indicator 316 from the ticket and adheres it to his outer clothing. The spectator may be photographed wearing the spectator indicator 316, while in an arena or other suitable location, preferably by one or more static cameras 320 and/or by one or more moving cameras 322. Any suitable type of photography may be employed, such as still photography, video photography and both digital and analog media may be employed.

The photographed content is preferably loaded in real time or promptly after an event to one or more servers 324. This content preferably includes seat location data corresponding to each spectator photographed wearing a spectator indicator 316. The seat location data may be derived from one or more sources, such as fixed viewable indicia in the arena or other location or outputs of an inertial or other suitable sensor. It is appreciated that photographs of spectators who are not wearing a spectator indicator 316 are not accessible. Servers 324 are preferably accessible via the Internet.

In accordance with a preferred embodiment of the present invention, a spectator or any other person having access to ticket 310 or who has otherwise received the seat location data may view any picture taken of a spectator located at the indicated seat location and wearing a spectator indicator 316 by entering a suitable web site and then, typically in response to suitable prompts, entering the seat location indicia 312.

In response to entry of the seat location indicia 312, the viewer sees a picture 326 of the spectator wearing the spectator indicator 316 and typically also views suitable advertising content 328. The viewer may then conveniently purchase a download of the picture 326 and any other ancillary products or services, such as T-shirts, mugs and e-mail greetings with pictures.

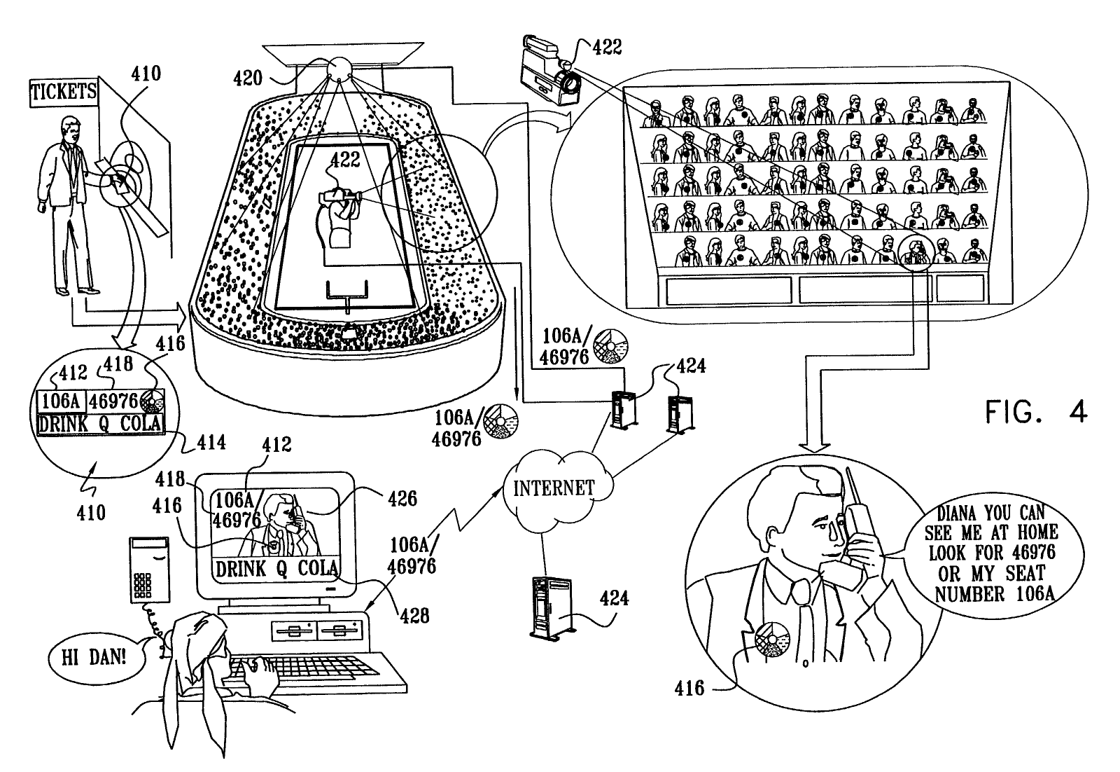

Reference is now made to FIG. 4 is a simplified pictorial illustration of a real-time photograph access feature applicable to the embodiments of FIGS. 1 & 2. As seen in FIG. 4, in accordance with a preferred embodiment of the present invention, a spectator at an event purchases or otherwise obtains a ticket 410, which typically includes, inter alia seat location indicia 412, advertising content 414, a removable spectator identifier 416 and a spectator identification code 418, which is keyed to the removable spectator identifier 416.

In accordance with a preferred embodiment of the present invention, the spectator identifier 416 comprises a multi-segment color coded tag, such as a tag 416 illustrated in FIGS. 10 and 19 and described at pages 13, 20 & 21 of applicant/assignee's published PCT Patent Application WO 00/04711, the disclosure of which is hereby incorporated by reference.

In accordance with a preferred embodiment of the present invention, the spectator removes the removable spectator identifier 416 from the ticket and adheres it to his outer clothing. The spectator is photographed wearing the spectator identifier 416, while in an arena or other suitable location, preferably by one or more static cameras 420 and/or by one or more moving cameras 422. Any suitable type of photography may be employed, such as still photography, video photography and both digital and analog media may be employed.

The photographed content is preferably loaded in real time to one or more servers 424. This content preferably includes at least one and possible both spectator identification data corresponding to each spectator identifier 416 photographed on a spectator and seat location indicia 412. Servers 424 are preferably accessible via the Internet.

In accordance with a preferred embodiment of the present invention, a spectator or any other person having access to ticket 410 or who has otherwise received the identification code 418, such as via a real time telephone call or any other suitable communication, may view in real time or thereafter any picture taken of a spectator wearing a spectator identifier 416 and/or located in a seat location identified by seat location indicia 412 by entering a suitable web site and then, typically in response to suitable prompts, entering the spectator identification code 418, which corresponds to the spectator identification data provided by the spectator identifier 416 or entering the seat location indicia 412.

In response to entry of the spectator identification code 418 and/or the seat location indicia 412, the viewer sees a picture 426 of the spectator and typically also views suitable advertising content 428. The viewer may then conveniently purchase a download of the picture 426 and any other ancillary products or services.

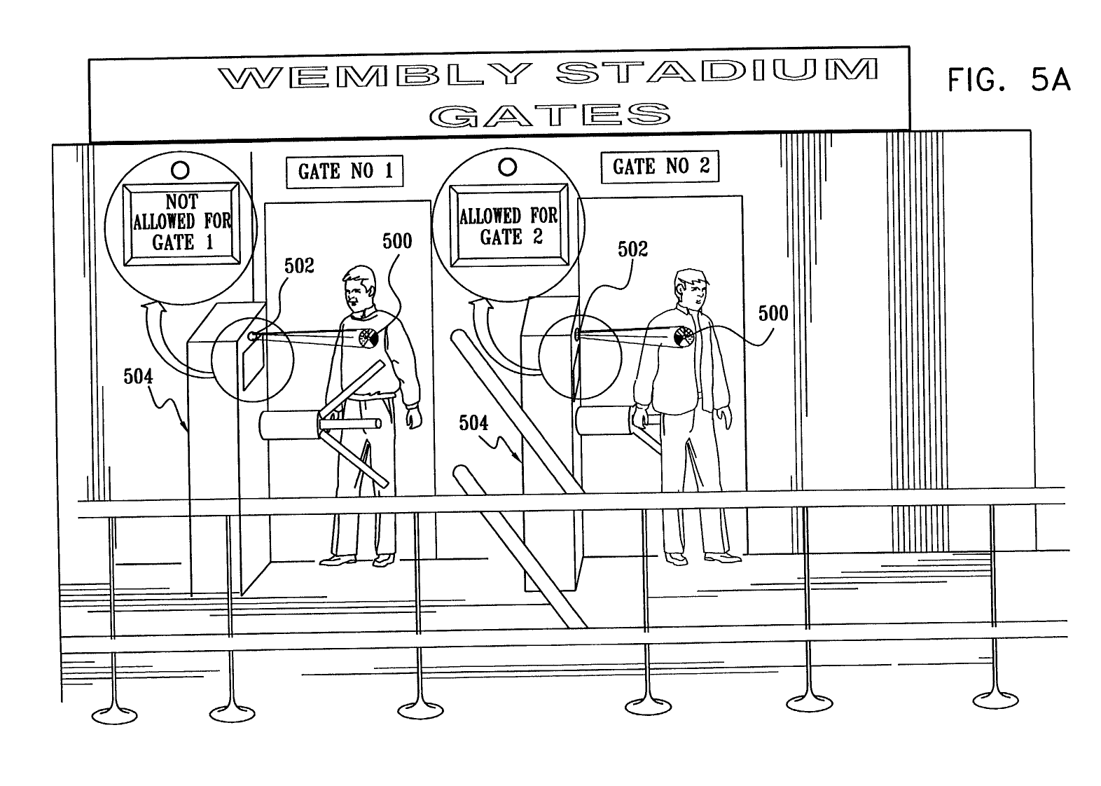

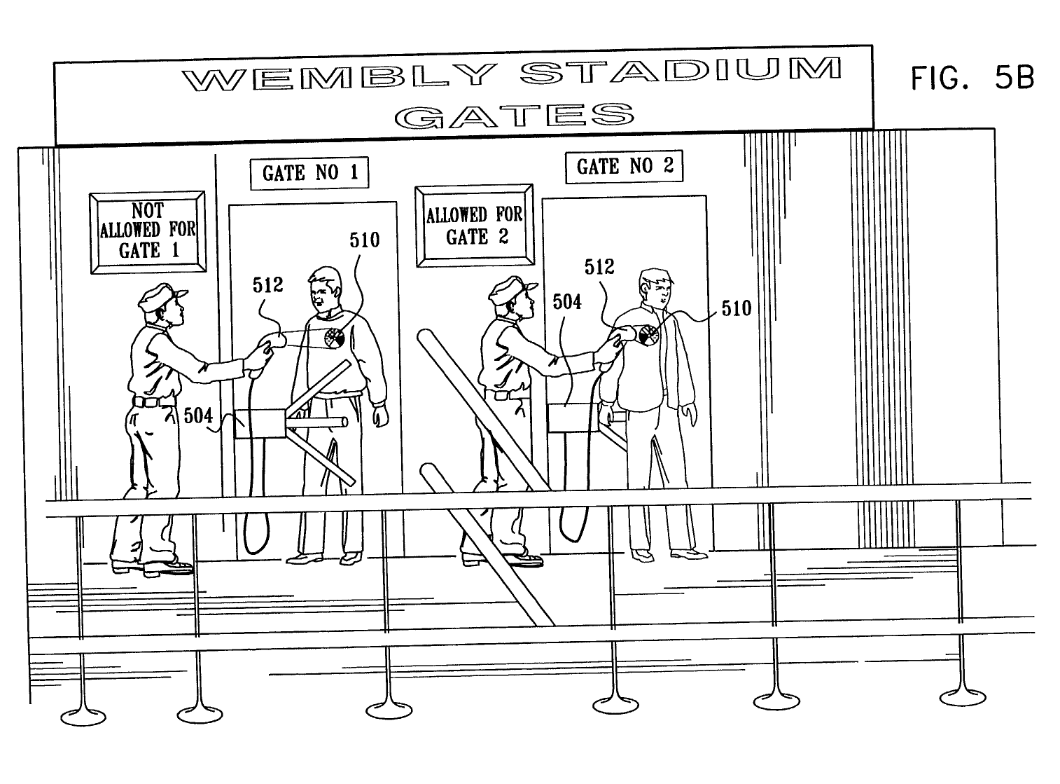

Reference is now made to FIGS. 5A and 5B, which are simplified pictorial illustrations of use of an image code for fully or partially automated access control at an event in accordance with two alternative embodiments of the present invention.

Turning to FIG. 5A it is seen that a spectator identifier 500, in addition to its functionality as described hereinabove, may be employed for automated access control. In the embodiment of FIG. 5A, a spectator identifier reader 502 incorporated in an automatic turnstile assembly 504 may provide access to given areas such as in an arena, to persons wearing spectator identifiers 500 which grant them predetermined access entitlements.

Turning to FIG. 5B it is seen that a spectator identifier 510, in addition to its functionality as described hereinabove, may be employed for partially automated access control. In the embodiment of FIG. 5B, a handheld spectator identifier reader 512 incorporated in an automatic turnstile assembly 504 may be used by an usher to indicate that persons wearing spectator identifiers 510 have entitlement to access predetermined areas.

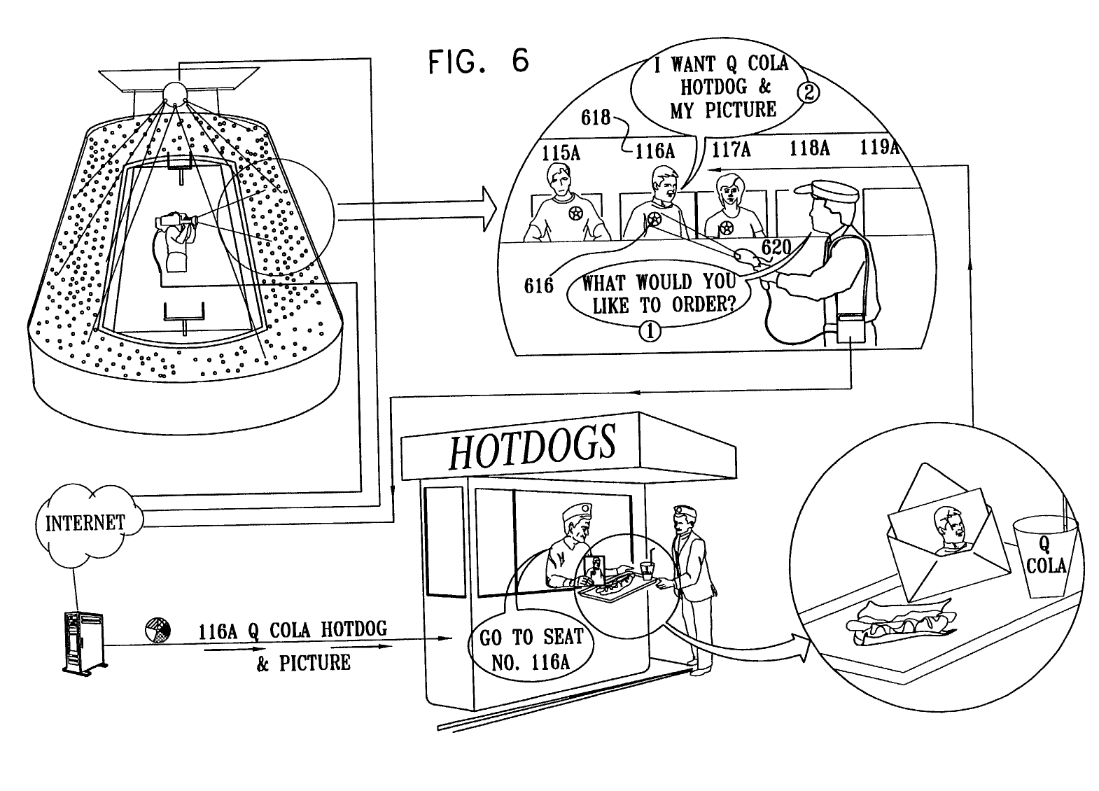

Reference is now made to FIG. 6, which is a simplified pictorial illustration of delivery of products to a spectator in accordance with a preferred embodiment of the present invention.

As seen in FIG. 6, in accordance with a preferred embodiment of the present invention, a spectator at an event wearing a spectator identifier 616 or being located in an identifiable seat location indicated by indicia 618 may be photographed using the functionality described hereinabove with reference to FIGS. 1-4. In addition to this functionality, the spectator may also purchase a picture as well as other products, such as, for example, food products. In accordance with a preferred embodiment of the present invention, at the time of ordering, the order taker scans either or both of the spectator identifier 616 and the spectator seat location indicia 618 by means of a scan device 620. The scan device 620 preferably also includes a recording unit (not shown) for recording the order placed by the spectator. The ordered products are then delivered to the spectator by using information derived from either or both of the spectator identifier 616 and the spectator seat location indicia 618.

It will be appreciated by persons skilled in the art that the present invention is not limited by what has been particularly shown and described hereinabove. Rather the scope of the present invention includes both combinations and subcombinations of the various features described hereinabove as well as variations and modifications which would occur to persons skilled in the art upon reading the specification and which are not in the prior art.

1. A system for providing photographs of spectators at an event comprising:
photography equipment, producing photographs of a plurality of spectators at an event; and
a correlator providing a correlation output correlating information contained in said photographs of said plurality of spectators with identifying information relating individual ones of said plurality of spectators to photographs of said individual ones of said plurality of spectators.

2. A system for providing photographs of spectators at an event according to claim 1 and wherein said correlator comprises:
first correlation functionality which employs individual identification information provided by identifiers worn by individual ones of said plurality of spectators, which individual identification information is extracted from said photographs.

3. A system for providing photographs of spectators at an event according to claim 1 and wherein said correlator comprises:
second correlation functionality which employs the assigned locations of individual ones of said plurality of spectators to provide individual identification information.

4. A system according to claim 1 and also comprising a distribution sub-system which is operative to make said photographs available to individual ones of said plurality of spectators appearing in said photographs on the basis of said correlation output.

5. A system according to claim 2 and also comprising a distribution sub-system which is operative to make said photographs available to individual ones of said plurality of spectators appearing in said photographs on the basis of said correlation output.

6. A system according to claim 3 and also comprising a distribution sub-system which is operative to make said photographs available to individual ones of said plurality of spectators appearing in said photographs on the basis of said correlation output.

7. A system according to claim 4 and wherein said distribution sub-system comprises:
an identifier-based indexer operative using information related to identifiers for identifying photographs in which identifier bearing individual ones of said plurality of spectators appear.

8. A system according to claim 5 and wherein said distribution sub-system comprises:
an identifier-based indexer operative using information related to identifiers for identifying photographs in which identifier bearing individual ones of said plurality of spectators appear.

9. A system according to claim 6 and wherein said distribution sub-system comprises:
an identifier-based indexer operative using information related to identifiers for identifying photographs in which identifier bearing individual ones of said plurality of spectators appear.

10. A system according to claim 4 and wherein said distribution sub-system comprises:
an assigned location-based indexer operative using information related to assigned locations of individual ones of said plurality of spectators for identifying photographs in which individual ones of said plurality of spectators at said assigned locations appear.

11. A system according to claim 5 and wherein said distribution sub-system comprises:
an assigned location-based indexer operative using information related to assigned locations of individual ones of said plurality of spectators for identifying photographs in which individual ones of said plurality of spectators at said assigned locations appear.

12. A system according to claim 6 and wherein said distribution sub-system comprises:
an assigned location-based indexer operative using information related to assigned locations of individual ones of said plurality of spectators for identifying photographs in which individual ones of said plurality of spectators at said assigned locations appear.

13. A system according to claim 4 and wherein said distribution sub-system also comprises a computer network based system wherein identifier based information is entered to receive access to photographs in which an identifier-based spectator appears.

14. A system according to claim 5 and wherein said distribution sub-system also comprises a computer network based system wherein identifier based information is entered to receive access to photographs in which an identifier-based spectator appears.

15. A system according to claim 6 and wherein said distribution sub-system also comprises a computer network based system wherein identifier based information is entered to receive access to photographs in which an identifier-based spectator appears.

16. A system according to claim 4 and wherein said distribution sub-system also comprises a computer network based system wherein location based information is entered to receive access to photographs in which a spectator appears at a given location.

17. A system according to claim 5 and wherein said distribution sub-system also comprises a computer network based system wherein location based information is entered to receive access to photographs in which a spectator appears at a given location.

18. A system according to claim 6 and wherein said distribution sub-system also comprises a computer network based system wherein location based information is entered to receive access to photographs in which a spectator appears at a given location.

19. A system according to claim 1 and also comprising a photograph classifier providing a photograph classification output classifying said photographs according to at least one classification criterion.

20. A system according to claim 19 and wherein said photograph classifier provides said classification output according to at least a classification criteria based on information contained in said photographs other than said identifying information.

21. A system according to claim 19 and wherein said photograph classifier provides said classification output according to at least a classification criteria based on information not contained in said photographs.

22. A system according to claim 21 and wherein said classification criteria includes sound information indicating the existence of spectator excitement.

23. A system according to claim 20 and wherein said classification criteria includes information indicating the existence of spectator excitement.

24. A system according to claim 20 and wherein said classification criteria includes information indicating presence of a given logo or symbol.

25. A system according to claim 20 and wherein said classification criteria includes information indicating that a spectator is identified with a given team or sponsor in a visually sensible manner.

26. A system according to claim 19 and also comprising an output device receiving said photograph classification output and providing a photograph classification dependent output.

27. A system according to claim 26 and wherein said output device is a still photograph storage device which stores photographs in accordance with said photograph classification output.

28. A system according to claim 26 and wherein said output device is a still photograph distribution device which makes photographs available for distribution in accordance with said photograph classification output.

29. A system according to claim 26 and wherein said output device is a still photograph selection device which selects photographs in accordance with said photograph classification output.

30. A system according to claim 26 and wherein said output device is an Internet still photograph distribution subsystem which makes photographs available for download in accordance with said photograph classification output.

31. A system according to claim 30 and wherein said Internet still photograph distribution subsystem includes an audio sound bite functionality, which makes concurrent sound bites available for download together with said photographs.

32. A method for providing photographs of spectators at an event comprising:
producing photographs of a plurality of spectators at an event; and
providing a correlation output correlating information contained in said photographs of said plurality of spectators with identifying information relating individual ones of said plurality of spectators to photographs of said individual ones of said plurality of spectators.

33. A method for providing photographs of spectators at an event according to claim 32 and wherein said correlating comprises:
first correlation functionality which employs individual identification information provided by identifiers worn by individual ones of said plurality of spectators, which individual identification information is extracted from said photographs.

34. A method for providing photographs of spectators at an event according to claim 32 and wherein said correlating comprises:
second correlation functionality which employs the assigned locations of individual ones of said plurality of spectators to provide individual identification information.

35. A method according to claim 32 and also comprising making said photographs available to individual ones of said plurality of spectators appearing in said photographs on the basis of said correlation output.

36. A method according to claim 33 and also comprising making said photographs available to individual ones of said plurality of spectators appearing in said photographs on the basis of said correlation output.

37. A method according to claim 34 and also comprising making said photographs available to individual ones of said plurality of spectators appearing in said photographs on the basis of said correlation output.

38. A method according to claim 35 and wherein said making comprises:
using information related to identifiers for identifying photographs in which identifier bearing individual ones of said plurality of spectators appear.

39. A method according to claim 36 and wherein said making comprises:
using information related to identifiers for identifying photographs in which identifier bearing individual ones of said plurality of spectators appear.

40. A method according to claim 37 and wherein said making comprises:
using information related to identifiers for identifying photographs in which identifier bearing individual ones of said plurality of spectators appear.

41. A method according to claim 35 and wherein said making comprises:
using information related to assigned locations of individual ones of said plurality of spectators for identifying photographs in which individual ones of said plurality of spectators at said assigned locations appear.

42. A method according to claim 36 and wherein said making comprises:
using information related to assigned locations of individual ones of said plurality of spectators for identifying photographs in which individual ones of said plurality of spectators at said assigned locations appear.

43. A method according to claim 37 and wherein said making comprises:
using information related to assigned locations of individual ones of said plurality of spectators for identifying photographs in which individual ones of said plurality of spectators at said assigned locations appear.

44. A method according to claim 35 and wherein said making comprises entering identifier based information into a computer network to receive access to photographs in which an identifier-based spectator appears.

45. A method according to claim 36 and wherein said making comprises entering identifier based information into a computer network to receive access to photographs in which an identifier-based spectator appears.

46. A method according to claim 37 and wherein said making comprises entering identifier based information into a computer network to receive access to photographs in which an identifier-based spectator appears.

47. A method according to claim 35 and wherein said making comprises entering location based information into a computer network to receive access to photographs in which an spectator appears at a given location.

48. A method according to claim 36 and wherein said making comprises entering location based information into a computer network to receive access to photographs in which an spectator appears at a given location.

49. A method according to claim 37 and wherein said making comprises entering location based information into a computer network to receive access to photographs in which an spectator appears at a given location.

50. A method according to claim 32 and also comprising providing a photograph classification output classifying said photographs according to at least one classification criterion.

51. A method according to claim 50 and wherein said classification output is provided according to at least one classification criterion based on information contained in said photographs other than said identifying information.

52. A method according to claim 50 and wherein said classification output is provided according to at least a classification criterion based on information not contained in said photographs.

53. A method according to claim 52 and wherein said at least one classification criterion includes sound information indicating the existence of spectator excitement.

54. A method according to claim 50 and wherein said at least one classification criterion includes information indicating the existence of spectator excitement.

55. A method according to claim 51 and wherein said at least one classification criterion includes information indicating presence of a given logo or symbol.

56. A method according to claim 51 and wherein said at least one classification criterion includes information indicating that a spectator is identified with a given team or sponsor in a visually sensible manner.

57. A method according to claim 50 and also comprising providing a photograph classification dependent output.

58. A method according to claim 57 and also comprising storing said photographs in accordance with said photograph classification dependent output.

59. A method according to claim 57 and also comprising making photographs available for distribution in accordance with said photograph classification dependent output.

60. A method according to claim 57 and also comprising selecting photographs in accordance with said photograph classification dependent output.

61. A method according to claim 57 and also comprising making photographs available for download via the Internet in accordance with said photograph classification dependent output.

62. A method according to claim 61 and also comprising making concurrent sound bites available for download together with said photographs.
